(19) United States
(12) Patent Application Publication
(10) Pub. No.: US 2026/0106570 A1
(43) Pub. Date: Apr. 16, 2026

(54) Short-Rail Photovoltaic Panel Mounting Bracket and Installation Method

(71) Applicant: Top Rack Technology, Inc., Moorestown, NJ (US)

(72) Inventor: Guohao Zhu, Haining City (CN)

(73) Assignee: Top Rack Technology, Inc., Moorestown, NJ (US)

(21) Appl. No.: 18/960,996

(22) Filed: Nov. 26, 2024

(30) Foreign Application Priority Data
Oct. 11, 2024 (CN) 202411420064.7

(51) Int. Cl. H02S 20/30

(52) U.S. Cl. CPC H02S 20/30

(57) ABSTRACT

The invention discloses a short rail photovoltaic (PV) panel mounting bracket and its installation method, designed for rooftop installation and fixing. It consists of a short rail and a base. The base includes a connecting part compatible with the short rail and fixing parts on both sides, each of which has multiple connection holes. The short rail has a mounting slot and a rectangular frame. The upper portion of the mounting slot is an open groove, which connects to an intermediate clamp used to mount the PV panel. The rectangular frame fits and locks with the connecting part, and there is a screw adjustment structure between the rectangular frame and the connecting part. The base's underside includes a layer of butyl adhesive and release paper. The screw adjustment structure consists of an upper nut, a bolt, and a lower nut, with threaded adjustment holes on the short rail and connecting part compatible with the bolt. Both the upper nut and the lower nut on the screw, as well as the bolt connection, contain fixed adhesive layers. This invention allows the PV panel mounting clamp to be fixed by connecting directly to the short rail, eliminating the need for long rail installation. This reduces costs, and the overall structure is simple and easy to install.

### TECHNICAL FIELD This invention relates to the field of solar photovoltaics, specifically to a short rail PV panel mounting bracket and its installation method.

### BACKGROUND TECHNOLOGY

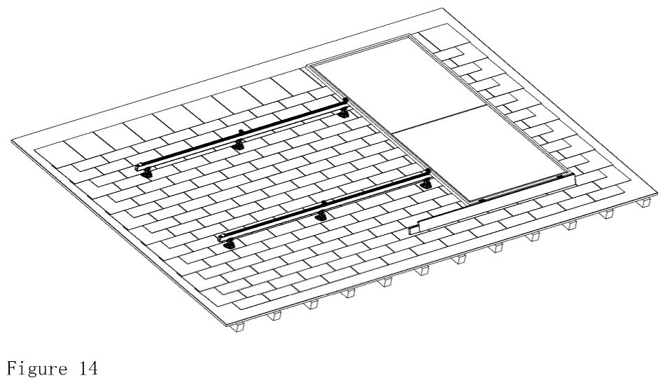

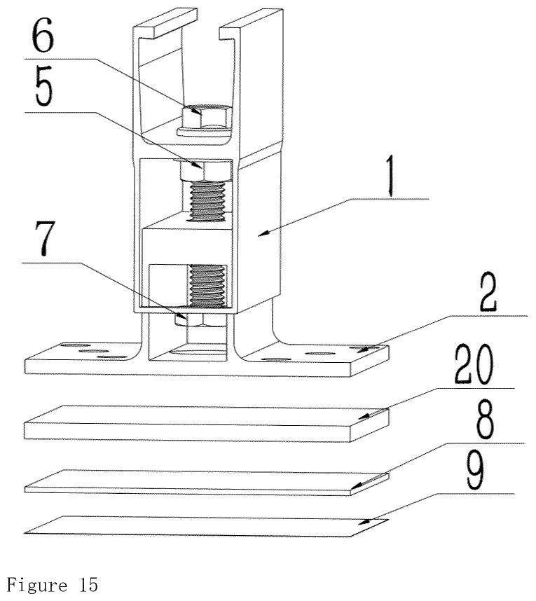

Currently, rooftop PV panel assemblies primarily include PV panels and mounting brackets, with the PV panels installed onto the roof via these brackets. Existing setups involve fixing rail bases onto the roof, followed by mounting individual rails to these bases. Each rail must be installed one by one, connected using a central key within the rail base (see FIG. 14). Once all rails are in place, the PV panels are installed, secured by clamps along the edges of the rails. Due to the individual rail installation, the process is complex, time-consuming, and inefficient.

### SUMMARY OF THE INVENTION

To address the limitations of current technology, this invention provides a short rail PV panel mounting bracket and installation method that features a simple structure, is easy to install, saves on rail material, and reduces costs.

To achieve these objectives, this invention proposes the following technical solution: A short rail PV panel mounting bracket, fixed to the roof, comprises a short rail and a base. The base includes a connecting part compatible with the short rail and fixing sections on each side, with multiple connection holes on each fixing section. The short rail comprises a mounting slot and a rectangular frame; the top of the mounting slot is open, allowing connection with an intermediate clamp for securing the PV panel. The rectangular frame fits with the connecting part, and a screw adjustment structure is set between the frame and the connecting part. The bottom of the base has a layer of butyl adhesive and release paper.

In a preferred embodiment, the screw adjustment structure includes an upper nut, a bolt, and a lower nut, with threaded adjustment holes on both the short rail and connecting part that are compatible with the bolt.

For further improvement, a fixed adhesive layer is provided within both the upper nut and the lower nut where the bolt attaches.

Further enhancements include side plates on the rectangular frame and limit strips at the front and back of the base.

Another improvement is an end cap on the outer edge of the short rail PV panel mounting bracket.

In a preferred embodiment, the butyl adhesive layer consists of two layers.

As an additional improvement, an EPDM gasket is provided between the base and the butyl adhesive layer.

### Method for Installing a PV Panel Using the Short Rail Bracket

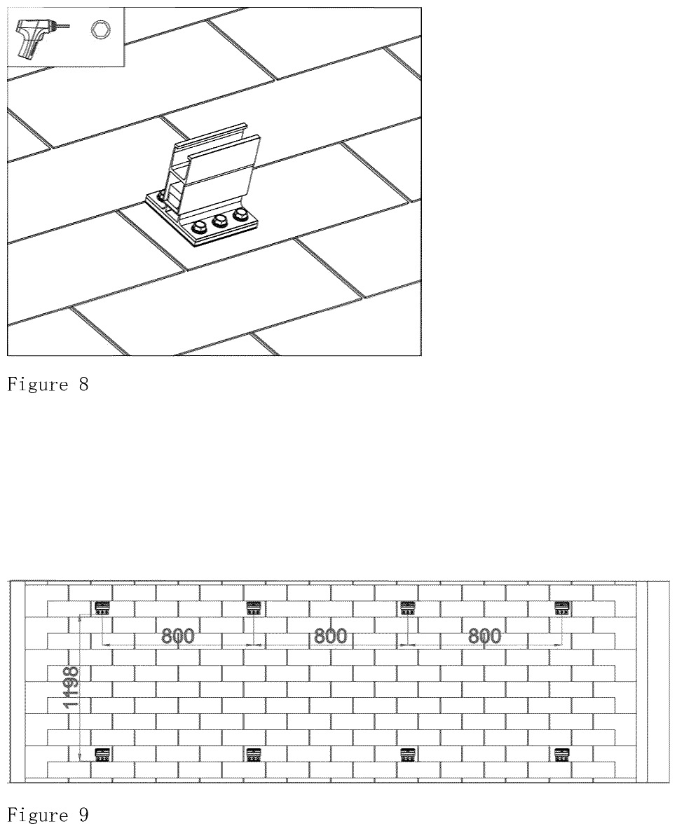

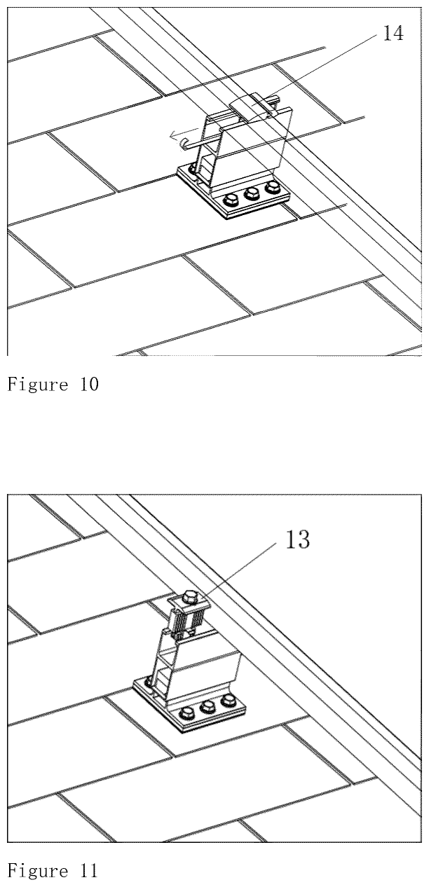

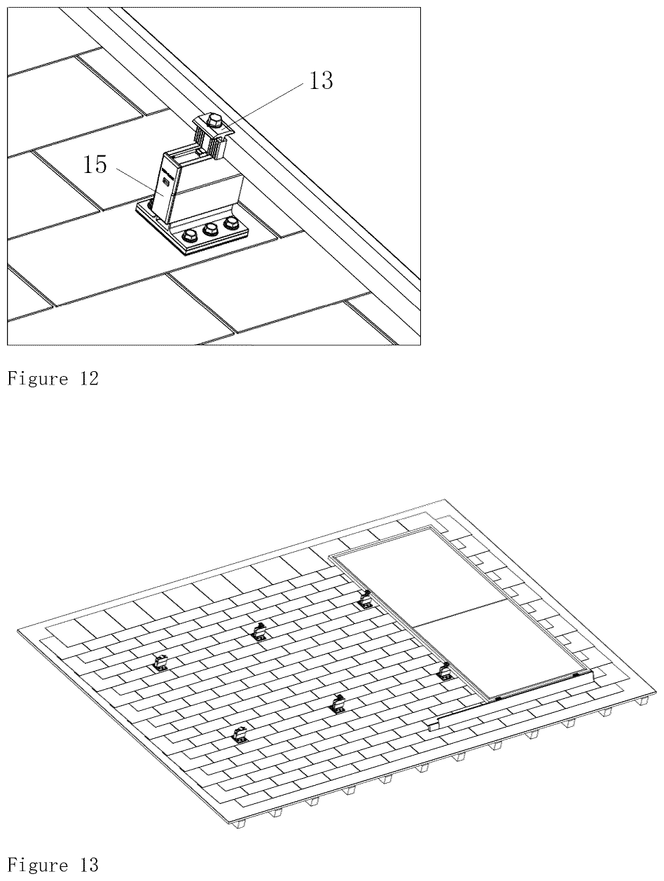

1. Placement: Arrange the short rail PV panel mounting brackets in the required positions, remove the release paper, and adhere the butyl adhesive layer to the desired spots (see FIG. 7). Secure each bracket to the roof using self-tapping screws (see FIG. 8).
2. Height Adjustment: Use the screw adjustment structure to level all brackets, ensuring that each short rail PV panel mounting bracket is at the same height (see FIG. 9).
3. Clamp Installation: Insert the hidden end clamp into the mounting slot (see FIG. 10), followed by the intermediate clamp (see FIG. 11). Rotate the intermediate clamp 90 degrees to lock it in place (see FIG. 12).
4. PV Panel Fixing: Secure each PV panel by fixing it within the intermediate clamps.

When using the screw adjustment structure, the fixed adhesive layers within the upper and lower nuts provide stability, securing the position and establishing upper and lower limits.

### Adhesive Layer Description

This invention's fixed adhesive layer utilizes Loctite 204 thread locking agent, a pre-applied adhesive for securing and sealing threaded fasteners. It remains inert on the fastener until assembly, at which point a quick-curing resin is released, filling all gaps within the threads. Once cured, it securely locks and seals the assembly.

### Advantages of the Invention

The PV panel mounting clamp connects with the short rail, eliminating the need for long rails and reducing costs. The compact structure is easy to install, and the screw adjustment structure enables leveling on slightly uneven roofs, resulting in better installation quality. The fixed adhesive layers within the nuts ensure stability, providing an upper and lower limit. Limit strips on the rectangular frame prevent movement during installation, while side plates on the sides maintain lateral balance. The end cap on the bracket provides protection and a smooth finish.

### ILLUSTRATIONS

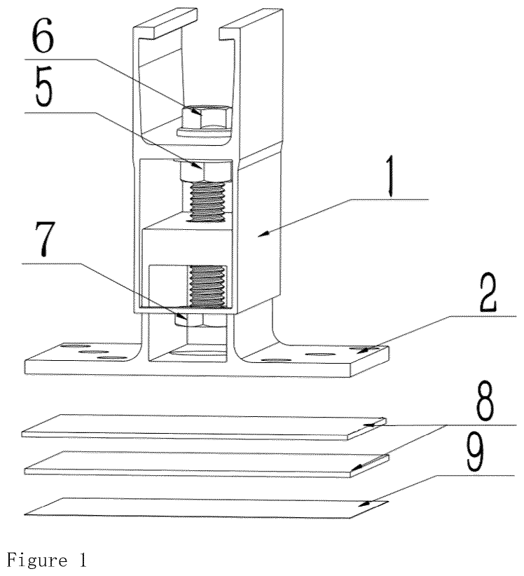

FIG. 1: Structural diagram of Example 1 of this invention.

FIG. 2: Diagram 1 of the base structure in Example 1.

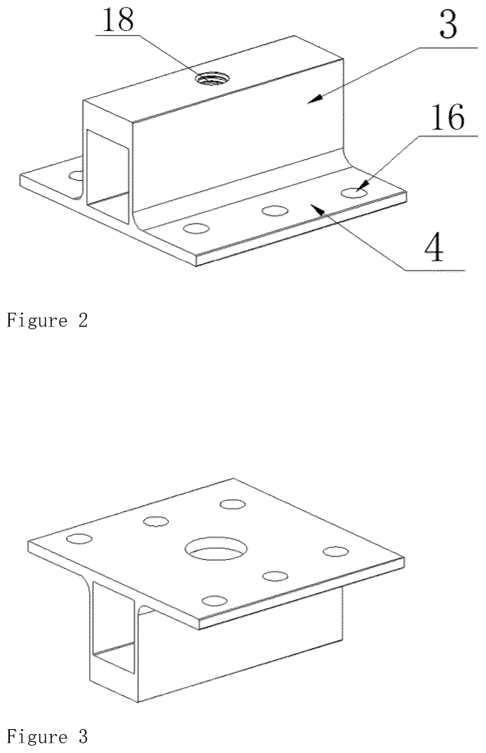

FIG. 3: Diagram 2 of the base structure in Example 1.

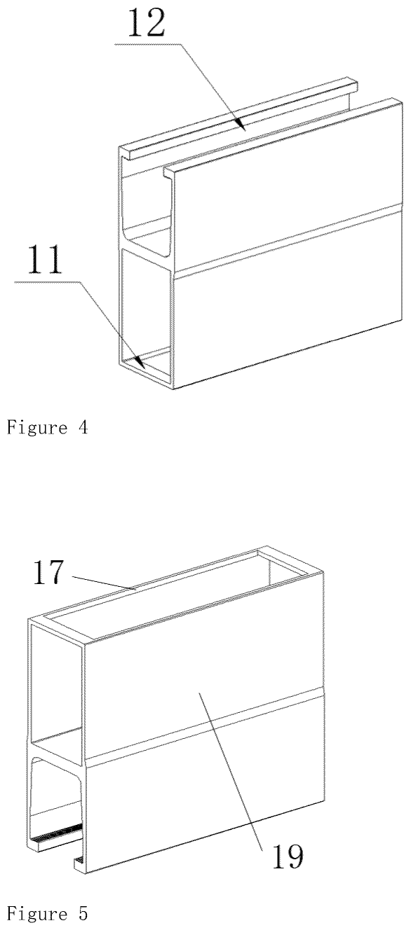

FIG. 4: Diagram 1 of the short rail structure in Example 1.

FIG. 5: Diagram 2 of the short rail structure in Example 1.

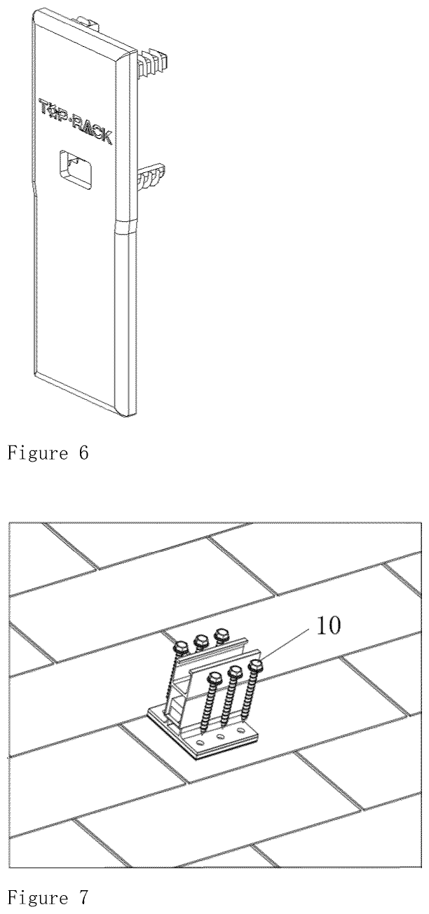

FIG. 6: End cap structure diagram in Example 1.

FIG. 7: Installation diagram 1 in Example 2.

FIG. 8: Installation diagram 2 in Example 2.

FIG. 9: Installation diagram 3 in Example 2.

FIG. 10: Installation diagram 4 in Example 2.

FIG. 11: Installation diagram 5 in Example 2.

FIG. 12: Installation diagram 6 in Example 2.

FIG. 13: Installation effect diagram in Example 2.

FIG. 14: Effect diagram of current technology installation.

FIG. 15: Structural diagram of Example 3 of this invention.

### COMPONENTS

1. Short rail; 2. Base; 3. Connecting part; 4. Fixing section; 5. Upper nut; 6. Bolt; 7. Lower nut; 8. Butyl adhesive layer; 9. Release paper; 10. Self-tapping screw; 11. Limit strip; 12. Mounting slot; 13. Intermediate clamp; 14. Hidden end clamp; 15. End cap; 16. Connection hole; 17. Rectangular frame; 18. Threaded adjustment hole; 19. Side plate; 20. EPDM gasket.

### DETAILED DESCRIPTION

The following description, along with accompanying diagrams, provides a clear and complete explanation of the technical solutions in the embodiments of this invention. The described embodiments are only part of the examples and do not encompass all variations. All other embodiments obtained by those skilled in the field without inventive labor fall within the scope of this invention.

Example 1: (See FIGS. 1-5) A short rail PV panel mounting bracket fixed to the roof includes a short rail (1) and a base (2). The base (2) has a central connecting part (3) and side fixing sections (4), each with multiple connection holes (16). The short rail (1) includes a mounting slot (12) and rectangular frame (17), where the upper part of the mounting slot (12) is open, allowing connection with the intermediate clamp (13) for securing the PV panel. A screw adjustment structure between the rectangular frame and connecting part (3) comprises an upper nut (5), bolt (6), and lower nut (7), with a fixed adhesive layer within both the upper and lower nuts. The short rail (1) and connecting part (3) each have threaded adjustment holes (18) compatible with the bolt (6). The connecting part (3) includes both an adjustable section and a hollow section to improve stability even with longer threaded holes. Side plates (19) and limit strips (11) are provided on the rectangular frame for further stability. The short rail's outer edge also includes an end cap (15) (see FIG. 6).

Example 2: A method for mounting a PV panel using the short rail bracket.
First, arrange the short rail PV brackets in position, remove the release paper (9), and adhere the butyl adhesive layer (8) to the marked spots (see FIG. 7). Secure each bracket to the roof with self-tapping screws (10) (see FIG. 8).
Second, adjust the height of all brackets to ensure uniformity (see FIG. 9).
Third, insert the hidden end clamp (14) into the mounting slot (12) (see FIG. 10), followed by the intermediate clamp (13) (see FIG. 11). Rotate the intermediate clamp 90 degrees to lock in place (see FIG. 12).
Fourth, fix each PV panel within the intermediate clamps (13).

Example 3: Another version of the short rail PV bracket includes an EPDM gasket (20) between the base and the butyl adhesive layer (see FIG. 15). All other aspects are similar to Example 1.

1. A short rail photovoltaic (PV) panel mounting bracket, comprising a short rail, a base, and an adjustment structure,
wherein the base comprises:
a connecting part for connecting the base to the short rail, and
fixing parts on opposite sides of bottom edges of the connecting part, each of the fixing parts comprising multiple holes;
wherein the short rail comprises:
a top mounting slot comprising an open groove for attaching the PV panel, and
a bottom box framework having an internal space for receiving the connecting part,
wherein the adjustment structure connects the short rail to the base and adjusts height of the short rail relative to the base.

2. The mounting bracket of claim 1, wherein the adjustment structure comprises an upper nut, a bolt, and a lower nut, wherein the short rail and the connecting part each comprise a hole for receiving the bolt, wherein the upper nut is in contact with the short rail, wherein movement of the bolt through the hole in the connecting part adjusts the height of the short rail relative to the base.

3. The mounting bracket of claim 1, further comprising a thread-locking adhesive layer on contact surface between the upper nut and the bolt and between the lower nut and the bolt.

4. The mounting bracket of claim 1, wherein the bottom box framework comprises side plates on opposite sides of the framework and restriction strips connecting the side plates.

5. The mounting bracket of claim 4, further comprising an end cap covering an end of the side plates.

6. The mounting bracket of claim 1, further comprising an immobilizing adhesive layer at an underside of the base, wherein the immobilizing adhesive layer is covered with a release paper.

7. The mounting bracket of claim 6, further comprising an spacer between bottom of the base and the immobilizing adhesive layer.

8. According to claim 6, wherein the immobilizing adhesive layer comprises two sub-layers.

9. A method for mounting a photovoltaic panel using the short rail mounting bracket of claim 1, comprising:
(a) positioning a plurality of the short rail mounting brackets in predetermined locations on a roof, and securing the short rail brackets to the roof,
(b) adjusting the height of each of the short rail brackets with the adjustment structure to ensure the brackets are level,
(c) securing a PV panel to the mounting bracket.

10. The method of claim 9, wherein in step (b) the adjustment structure comprises an upper nut, a bolt, and a lower nut, wherein the short rail and the connecting part each comprises a hole for receiving the bolt, wherein a thread-locking adhesive layer is present on contact surface between the upper nut and the bolt and between the lower nut and the bolt.

11. The method of claim 9, wherein step (c) comprises attaching a first clamp and a second clamp sequentially to the mounting slot, turning the second clamp by 90 degree, and securing the PV panel to the second clamp.
